(19) United States
(12) Patent Application Publication
(10) Pub. No.: US 2004/0184877 A1
(43) Pub. Date: Sep. 23, 2004

(54) Ultrasound coupling

(76) Inventors: Bernhard Sander, Munich (DE); Juergen Muendle, Satteins (AT)

Correspondence Address: DAVID TOREN, ESQ., SIDLEY, AUSTIN, BROWN & WOOD, LLP, 787 SEVENTH AVENUE, NEW YORK, NY, 10019-6018, US

(21) Appl. No.: 10/734,424

(22) Filed: Dec. 12, 2003

(30) Foreign Application Priority Data
Dec. 13, 2002 (DE) 102 58 297.1

(51) Int. Cl. F16B 1/00

(52) U.S. Cl. 403/348

(57) ABSTRACT

A coupling (1) transmits ultrasound energy along an independent axis (A) between a tool receptacle (2) and a tool (3) having two contact means (4a, 4b) directed opposite each other, which can be axially biased using a pre-stressing, biasing means (5), wherein at least one contact means (4a, 4b) has at least one axially directed, linear or pointform contact tip (6).

### BACKGROUND OF THE INVENTION

1. Field of the Invention

The invention relates to a coupling for the transmission of oscillations between two structural components, in particular for transmitting ultrasound energy between a tool receptacle and a tool for working rock, concrete, and the like.

2. Description of the Prior Art

Conventionally, contact surfaces, pressure-biased relative to each other in the direction of propagation, are used for transmitting longitudinal body waves in the form of ultrasound oscillations between two structural components in contact over a wide area.

According to WO 9 218 861 several spatially and directionally distributed contact surfaces are arranged in a pointform for measuring transmission of ultrasound energy to a probe. This solution is not suitable for the transmission of power to a tool.

FR 2 579 123 and WO 9 222 259 disclose two axially pre-stressed contact surfaces between a tool receptacle and a tool using a screw thread, which are configured axially over a wider surface. Particularly when working on brittle materials, high degrees of fouling occur on the tools, which must be laboriously cleaned before each coupling operation, which is uncommon in rough construction trades.

### SUMMARY OF THE INVENTION

The object of the invention is to provide a coupling for the transmission of ultrasound energy between a tool receptacle and a tool, which can also be used in cases of high degrees of fouling.

Essentially, when coupling for transmission of ultrasound energy along an independent axis between a tool receptacle and a tool, two opposingly directed contact surfaces are present, which can be axially pre-stressed, whereby at least one contact means has at least one axially directed, linear or pointform contact tip. Linear is not limited to rectilinear but may be curvilinear or annular.

In virtue of the axially directed contact tips, fouling present between the contact means in conditions of high degrees of fouling is urged laterally and the ultrasound transmitted via the contact tips imbedded in the opposing contact means.

Advantageously, a plurality of contact tips are spaced apart over the contact means, whereby the useful substrate zone is enlarged for the transmission.

Advantageously, the contact tip is configured linearly, whereby point like beddings are avoided, which can cause plastic deformations.

Advantageously, both contact means have contact tips directed towards each other, whereby the interspaces are enlarged for the fouling.

Advantageously, the linearly formed contact tips are shaped annularly, whereby they correspond to the symmetry of a rotationally symmetrical coupling.

Advantageously, the pre-stressing means is configured as an axially directed screw threaded stressing arrangement, whereby the coupling is effected by a conventional screw-type connection.

### BRIEF DESCRIPTION OF THE DRAWINGS

The invention will be more completely explained with reference to advantageous exemplary embodiments, in which:

FIG. 1 is an axially extending side view of a coupling shown partly in section;

FIG. 2 is another embodiment of the invention shown in an axially extending side view partly in section; and

FIG. 3a-FIG. 3d are different embodiments of contact tips shown in perspective representation.

### DETAILED DESCRIPTION OF THE PREFERRED EMBODIMENTS

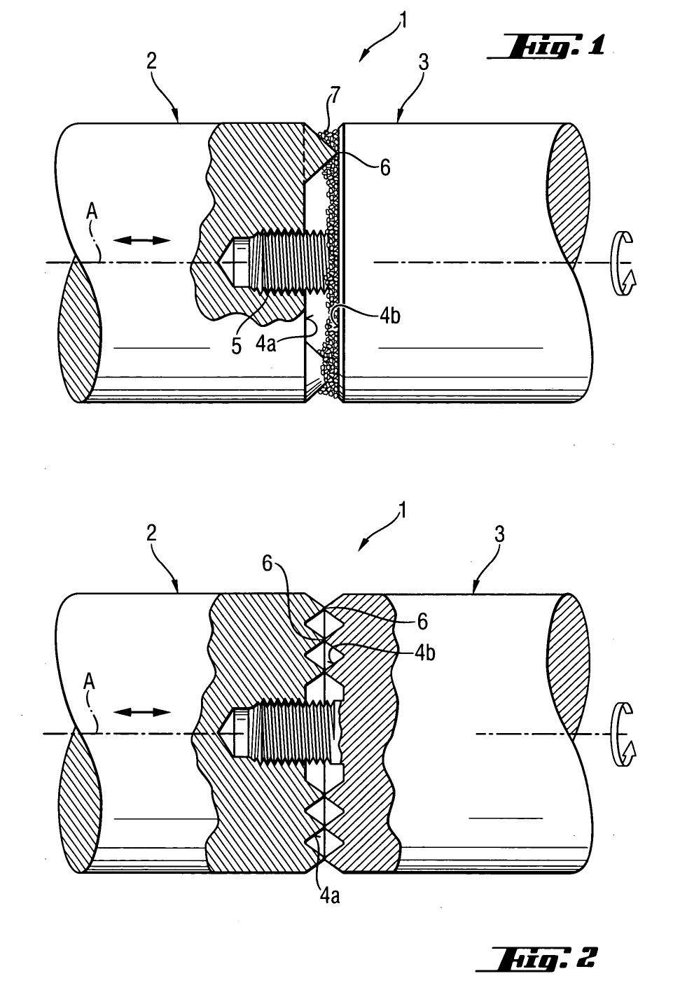

According to FIG. 1, in a coupling 1 for transmission of ultrasound energy, two contact means 4a, 4b directed opposing each other are arranged along an independent axis A between a tool receptacle 2 and a tool 3, the contact means 4a, 4b are capable of being axially pre stressed using a pre-stressing means 5 formed as an axially directed screw-thread tensioning means. The contact means 4a has a plurality of spaced, axially directed pointform contact tips 6, which urge fouling 7 laterally.

According to FIG. 2, in a rotationally symmetrical coupling 1 contact tips 6 are directed facing towards each other on both contact means 4a, 4b and are arranged in a ring configuration and linearly coaxially engage each other.

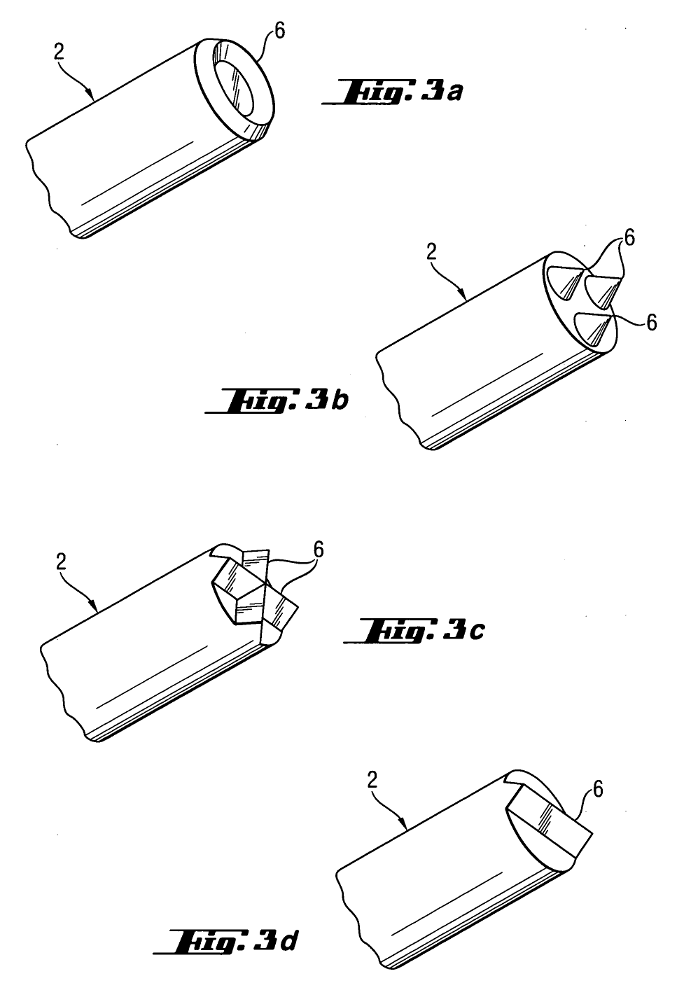

According to FIG. 3a-FIG. 3d many different contact tip embodiments, represented exclusively on the tool receptacle 2, are possible. FIG. 3a represents an annular or ring shaped linear contact tip 6, FIG. 3b shows three pointform contact tips 6, FIG. 3c has two crossing linear contact tips 6 and FIG. 3d shows a diagonally extending linear contact tip 6.

What is claimed is:

1. A coupling for transmitting ultrasound energy along an independent axis (A) between a tool receptacle (2) and a tool (3) with two oppositely directed contact means (4a, (4a, 4b) facing one another capable of being prestressed axially by a prestressing means (5), wherein at least one of said contact means (4a, 4b) has at least one of an axially directed linear contact tip and a pointform contact tip (6).

2. A coupling, as set forth in claim 1, wherein a plurality of contact tips (6) are spaced apart forming said contact means (4a, 4b).

3. A coupling, as set forth in claim 1, wherein said contact means (4a, 4b) comprises pointform contact tips on each of said tool receptacle (2) and tool (3) directed into point contact with one another.

4. A coupling, as set forth in claim 1, wherein said contact tips (6) extend linearly.

5. A coupling, as set forth in claim 4, wherein said said linearly extending contact tips (6) extending at least in part annularly.

6. A coupling, as set forth in claim 5, wherein said contact tips (6) are ring shaped.

7. A coupling, as set forth in claim 1, wherein said prestressing means comprises an axially directed screw-thread biasing member.

8. A coupling, as set forth in claim 7, wherein said screw thread biasing member extends axially from said tool receptacle (2) into a threaded bore extending axially into said tool (3).
